(19) United States
(12) Patent Application Publication
(10) Pub. No.: US 2014/0173407 A1
(43) Pub. Date: Jun. 19, 2014

(54) PROGRESSIVELY TRIGGERED AUTO-FILL

(71) Applicant: Empire Technology Development LLC, Wilmington, DE (US)

(72) Inventor: Ezekiel Kruglick, Poway, CA (US)

(73) Assignee: Empire Technology Development LLC, Wilmington, DE (US)

(21) Appl. No.: 13/885,996

(22) PCT Filed: Dec. 17, 2012
(86) PCT No.: PCT/US12/70208

§ 371 Date: May 16, 2013

(51) Int. Cl. G06F 17/24

(52) U.S. Cl. CPC G06F 17/243
USPC 715/226

(57) ABSTRACT

Technologies are presented for a multi-step progressive auto-fill function that allows a series of gestures or touches to activate and guide an auto-fill function suitable for information entry. A first gesture may call forth a group of contextual domains for information. A subsequent gesture or motion may cause the selection of a contextual domain, and another action may allow the selection of particular content for placement at a location indicated by the first gesture.

### BACKGROUND

Unless otherwise indicated herein, the materials described in this section are not prior art to the claims in this application and are not admitted to be prior art by inclusion in this section.

Many tasks in computer use involve entering information, and often it is information that has occurred in some form in some previous work or document. Whether entering an email address or typing a website address, such tasks may occur frequently, involve the repetitive entry of similar information, and may be much slower in gesture-controlled environments lacking real keyboards. While “cut-and-paste” functionalities are available to facilitate the entry of previously-occurring information, in general these functionalities require that a user initially find the previously-occurring information to cut, which may further slow the input process.

### SUMMARY

The present disclosure generally describes techniques for providing auto-fill functionality for complex inputs through context-based, progressive interaction.

According to some examples, a method for employing progressively-triggered auto-fill may include detecting a first action for activating a multi-stage auto-fill, determining a context of a requested input, presenting two or more contextual domains of content based on the context of the requested input, and upon selection of one of the contextual domains through a second action, presenting one or more content options suitable for selection in response to the requested input.

According to other examples, a computing device for employing progressively-triggered auto-fill may include a display configured to present a user interface that includes a requested input, an input device configured to detect an action, a memory configured to store instructions, and a processor communicatively coupled to the display, the input device, and the memory. The processor may be configured to detect a first action associated with the input device for activating a multi-stage auto-fill, determine a context of the requested input, present two or more contextual domains of content based on the context of the requested input through the user interface, and upon selection of one of the contextual domains through a second action associated with the input device, present one or more content options suitable for selection in response to the requested input through the user interface.

According to further examples, a system for employing progressively-triggered auto-fill may include at least one server configured to host a service accessible through a client application. The service may be configured to present content through a user interface that includes a requested input, detect a first action for activating a multi-stage auto-fill, determine a context of the requested input, present two or more contextual domains of content based on the context of the requested input through the user interface, and upon selection of one of the contextual domains through a second action associated with the input device, present one or more content options suitable for selection in response to the requested input through the user interface.

According to yet further examples, a computer-readable storage medium may store instructions which, when executed on one or more computing devices execute a method for employing progressively-triggered auto-fill. The instructions may include detecting a first action for activating a multi-stage auto-fill, determining a context of a requested input, presenting two or more contextual domains of content based on the context of the requested input, and upon selection of one of the contextual domains through a second action, presenting one or more content options suitable for selection in response to the requested input.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example networked system, where gesture progression may be employed for triggering auto-fill;

FIG. 2 illustrates challenges associated with entering information when using a touch/gesture based device such as reduction of display area due to virtual keyboard, availability of keys, and so on;

FIG. 3 illustrates a first operation in an example address auto-fill action;

FIG. 4 illustrates a subsequent operation in the example address auto-fill action of FIG. 3;

FIG. 5 illustrates selection of auto-fill content in the example user interface of FIG. 4;

FIG. 6 illustrates a general purpose computing device, which may be used to employ gesture progression to trigger auto-fill;

FIG. 7 is a flow diagram illustrating an example method for employing gesture progression to trigger auto-fill that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, systems, devices, and/or computer program products related to providing auto-fill functionality for complex inputs through context-based, progressive interaction.

Briefly stated, technologies are generally described for a multi-step progressive auto-fill function that allows a series of gestures or touches to activate and guide an auto-fill function suitable for information entry. A first gesture may call forth a group of contextual domains for information. A subsequent gesture or motion may cause the selection of a contextual domain, and another action may allow the selection of particular content for placement at a location indicated by the first gesture.

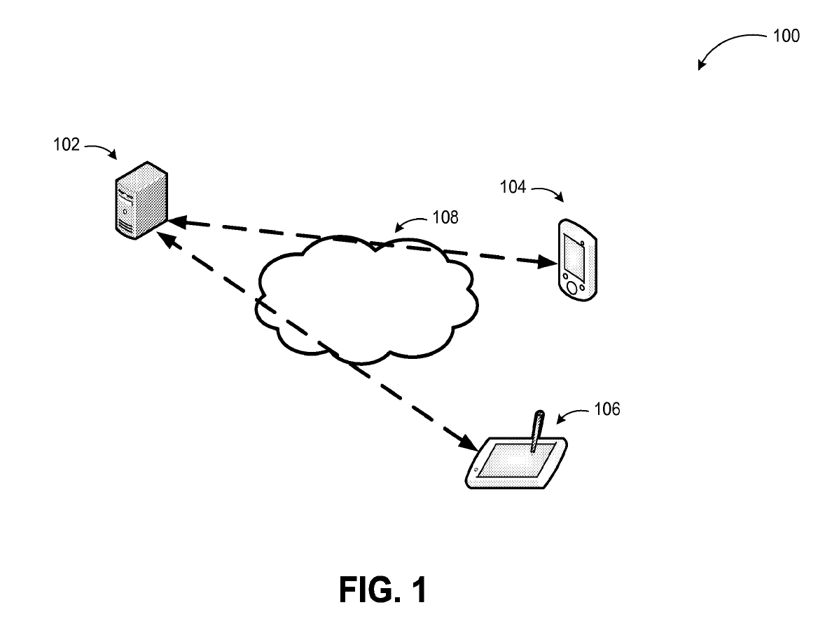

FIG. 1 illustrates an example networked system, where gesture progression may be employed for triggering auto-fill, arranged in accordance with at least some embodiments described herein.

As shown in a diagram 100, a first user device 104 (e.g., a smartphone) and a second user device 106 (e.g., a tablet computer) may communicate with one or more servers 102. The first user device 104 and/or the second user device 106 may communicate with the server 102 directly and/or via a network 108 (e.g., the Internet). In some embodiments, the first user device 104 and/or the second user device 106 may receive user inputs via a touch- or gesture-based user interface, such as a touchscreen or motion-capture input device.

Many online transactions may involve a user providing textual information to a server (e.g., the server 102) via, e.g., one or more input fields. For example, a user may log in to a web server by providing a username and a password. A user may perform a web search by entering one or more keywords into a search field. A user who wishes to make an online purchase may provide order information such as a shipping name, a shipping address, and/or payment information. In many instances, this information may have occurred in some form in some previous work or document (e.g., in a previous web search or online purchase).

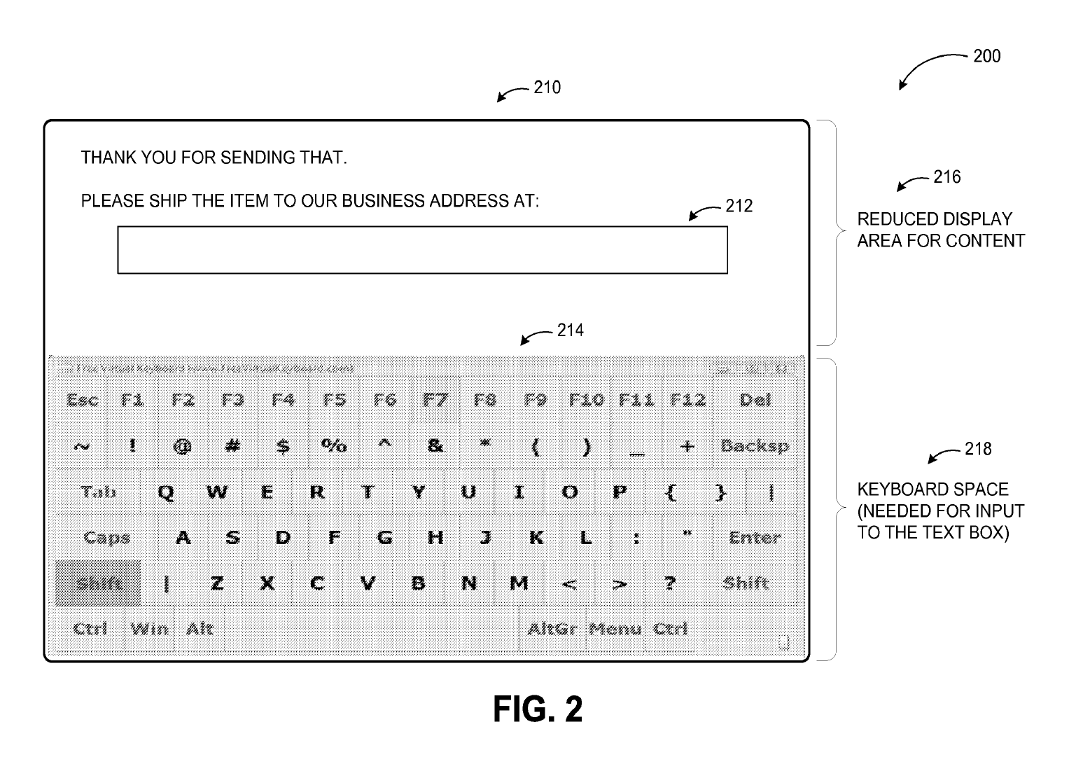

FIG. 2 illustrates challenges associated with entering information when using a touch/gesture based device such as reduction of display area due to virtual keyboard, availability of keys, and so on, arranged in accordance with at least some embodiments described herein.

As shown in a diagram 200, a touch/gesture-based device (e.g., the first user device 104 or the second user device 106) may include a touch-enabled display 210. When a user wishes to enter information in a text entry field 212, e.g. for an online transaction as described above, an application executed on the device or an operating system of the device may provide a touch or gesture interface on the display 210. For example, a touch-enabled virtual keyboard 214 may be presented on the display 210.

However, touch interfaces such as the virtual keyboard 214 may have several disadvantages. For example, the virtual keyboard 214 may provide less physical feedback and/or be less precise than a physical keyboard, resulting in slower and more laborious data entry. Another disadvantage is that the virtual keyboard 214 (or similar touch interfaces) may occupy a significant portion 218 of the touch-enabled display 210, resulting in a reduced display area 216 for displaying or presenting content. Further, even if the virtual keyboard 214 occupies the significant portion 218, there may not be enough space on the display 210 to show all of the characters or keys a user may need to enter information, which may result in even slower information input.

As described previously, cut-and-paste functionalities may be used to facilitate the entry of repetitive, previously-occurring information, which may be burdensome especially on a touch interface. However, such functionalities generally require that a user initially find the previously-occurring information to cut or copy, which may further slow the input process. A multi-step progressive auto-fill function as presented herein may facilitate such information entry by coupling a gesture-based activation and information selection process with context-based information organized in contextual domains. In some examples, the contextual domains may be dynamically-composed.

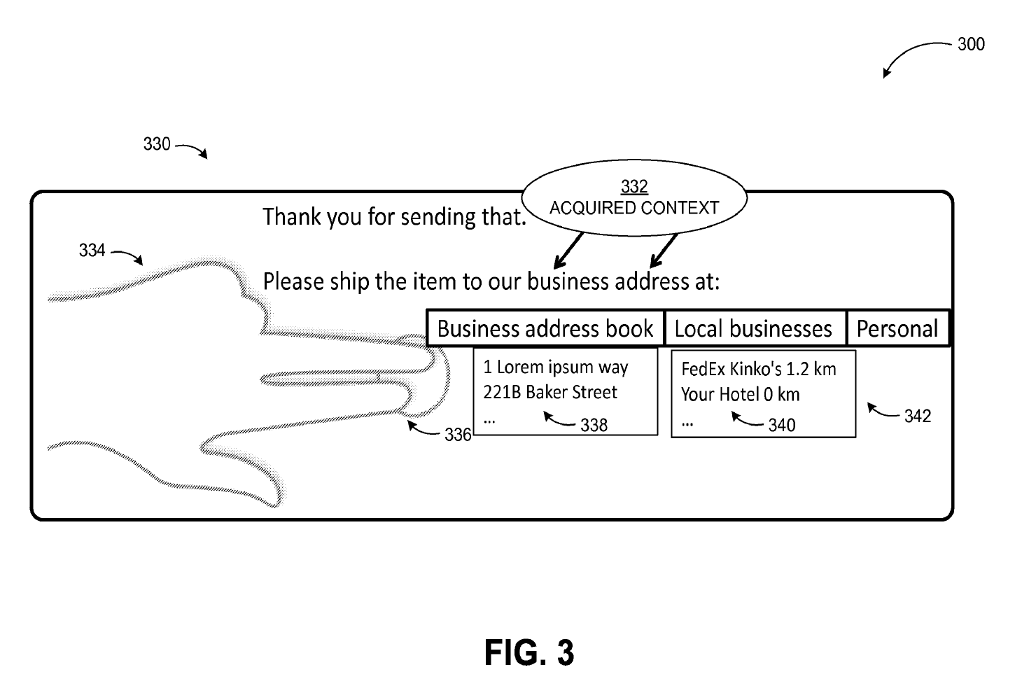

FIG. 3 illustrates a first operation in an example address auto-fill action, arranged in accordance with at least some embodiments described herein.

As shown in a diagram 300, a touch-gesture based device (e.g., the first user device 104 or the second user device 106) may include a touch-enabled display 330, similar to the touch-enabled display 210. When a user 334 wishes to enter information in an input field, the user 334 may enable an auto-fill process using a gesture 336. The gesture 336 may involve a touch on the display 330 and/or a gesture on or near the display 330. In some embodiments, the gesture 336 may be made with a single finger or multiple fingers, in particular orientations. For example, the gesture 336 may be a two-fingered horizontal touch, as shown in the diagram 300. In some embodiments, the gesture 336 may be a series of one or more movements or gestures.

When the user 334 makes the gesture 336, an application being executed on the device or an operating system of the device may use one or more pieces of acquired context 332 near the gesture 336 to begin the auto-fill process. In some embodiments, if the gesture 336 is made on a text entry field (e.g., the text entry field 212 in FIG. 2), the application executing on the device or the operating system of the device may gather the one or more pieces of acquired context 332 from words, images, links, or other data near the text entry field. For example, in the diagram 300, the acquired context 332 may include the words “business” and “address”. In some embodiments, the acquired context 332 may include text or information that the user has previously entered into a text entry field (e.g., the text entry field 212 in FIG. 2). For example, if the user had previously entered the word “profit” into a text entry field, the word “profit” may be included in the acquired context 332. In some embodiments, the acquired context 332 may include tags associated with a web page or the presented content and/or a field identifier associated with the entry field.

Subsequently, the application executing on the device or the operating system of the device may dynamically compose and display one or more contextual domains having information that correspond to the acquired context 332. In some embodiments, information relevant to the acquired context 332 may be gathered or inferred and organized in one or more contextual domains. For example, if the acquired context 332 includes “business” and “address”, a contextual domain 338 may be provided with addresses selected from the user's business address book and/or a contextual domain 342 with addresses selected from the user's personal address book. A location context (i.e., the current location of the user) may also be used to provide a contextual domain 340 having the addresses of local businesses (such as local shipping companies or the user's hotel).

In some embodiments, natural language processing may be used on the acquired context 332 to determine potentially associated contextual domains and/or information. For example, “concordance” operations may be performed on one or more non-common words located nearest a user-selected location (e.g., the location of gesture 336) to determine other instances of user-provided information where one or more of the non-common words occur. These other instances may then be used to determine and/or populate potential contextual domains. As an example, if a user enters the word “profit” in a text entry field, other occurrences of “profit” in information previously entered by or otherwise associated with the user may be determined. These other occurrences, and more specifically the context and information surrounding these other occurrences, may then be used to determine and populate contextual domains. In some embodiments, professional data, such as that in the contextual domain 338, may be separated from personal data, such as that in the contextual domain 342, to prevent cross-usage of confidential material. For example, professional and personal data may be separated by directory structure, keywords, and/or sources.

In some embodiments, collaborative filtering may be used to assist the generation or population of contextual domains. Collaborative filtering may be used to provide information (e.g., text) that, while not necessarily associated with particular pieces of acquired context, may have been used in similar situations. For example, if the acquired context includes “profit”, collaborative filtering may produce words such as “loss”, “earnings”, “income”, “sales”, “gain”, “export”, “shares”, etc.

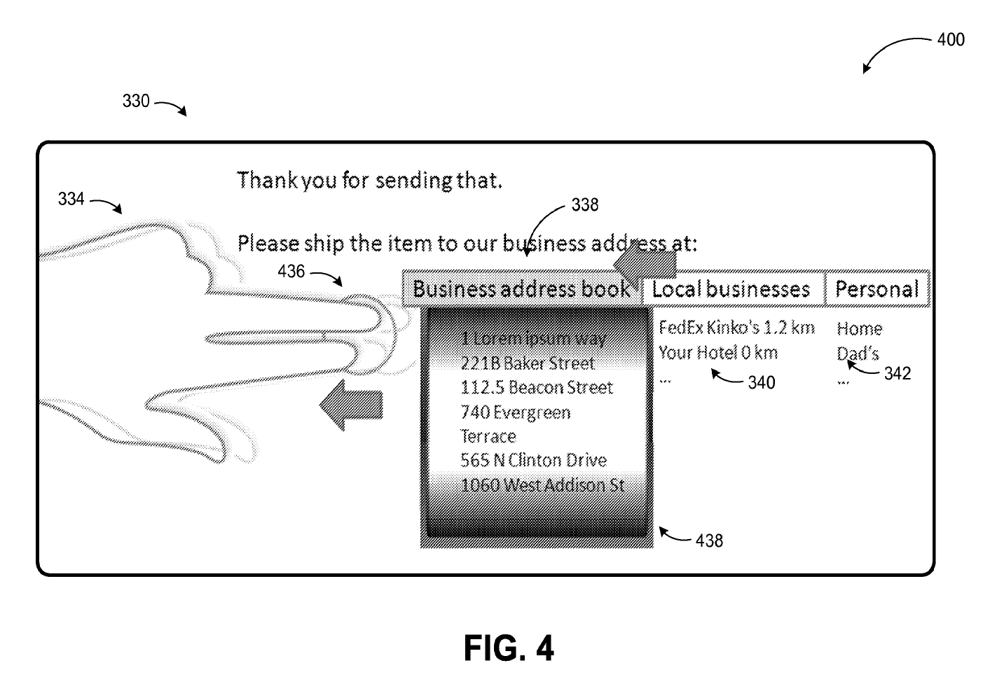

FIG. 4 illustrates a subsequent operation in the example address auto-fill action of FIG. 3, arranged in accordance with at least some embodiments described herein.

FIG. 4 depicts a diagram 400 similar to the diagram 300 in FIG. 3. In the diagram 400, the user 334 may have begun the auto-fill process by making the gesture 336, resulting in the presentation of the contextual domains 338, 340, and 342. Subsequently, the user 334 may perform a gesture 436 to select one of the presented contextual domains. For example, if the gesture 336 is a touch using two fingers, the gesture 436 may include moving the two fingers contacting the display 330 in order to select a presented contextual domain. In the example shown in the diagram 400, the presented contextual domains may be arranged in a linear fashion, with the domain 338 to the left of the domain 340, which in turn is to the left of the domain 342. If the user 334 performs the gesture 436 by sliding the two fingers in contact with the display 330 to the left, the contextual domain to the left (i.e. the contextual domain 338) may be selected. If the gesture 436 had been to the right, the contextual domain to the right (i.e., the contextual domain 342) may have been selected. In some embodiments, the central contextual domain (i.e., the contextual domain 340) may be selected if the gesture 436 is upward, downward, or if the user 334 had left two fingers touching the display 330 for some period of time. Upon selecting a presented contextual domain, a selection menu 438 may be presented. In some embodiments, the contextual domains and/or the selection menu 438 may be presented as a drop-down list, a rolling list, a radial menu, a grid menu, or any other suitable menu or list.

While only three contextual domains are depicted, more or fewer contextual domains may be presented, and the user 334 may select from the presented contextual domains by varying the extent of the gesture 436. For example, if the gesture 436 includes a large movement to the left, the leftmost contextual domain may be selected, whereas if the gesture 436 includes a relatively smaller movement to the left, a contextual domain to the left (but not the leftmost) may be selected. Similarly, while the depicted contextual domains are presented in a linear fashion, in other embodiments contextual domains may be presented in a circle, an arc, a grid, an array, or any other suitable arrangement. Similarly, while the selection menu 438 is presented in response to the selection of the contextual domain 338, in some embodiments the selection menu may instead be more contextual domains, or arranged in a linear fashion, in a circle, an arc, a grid, an array, or any other suitable arrangement.

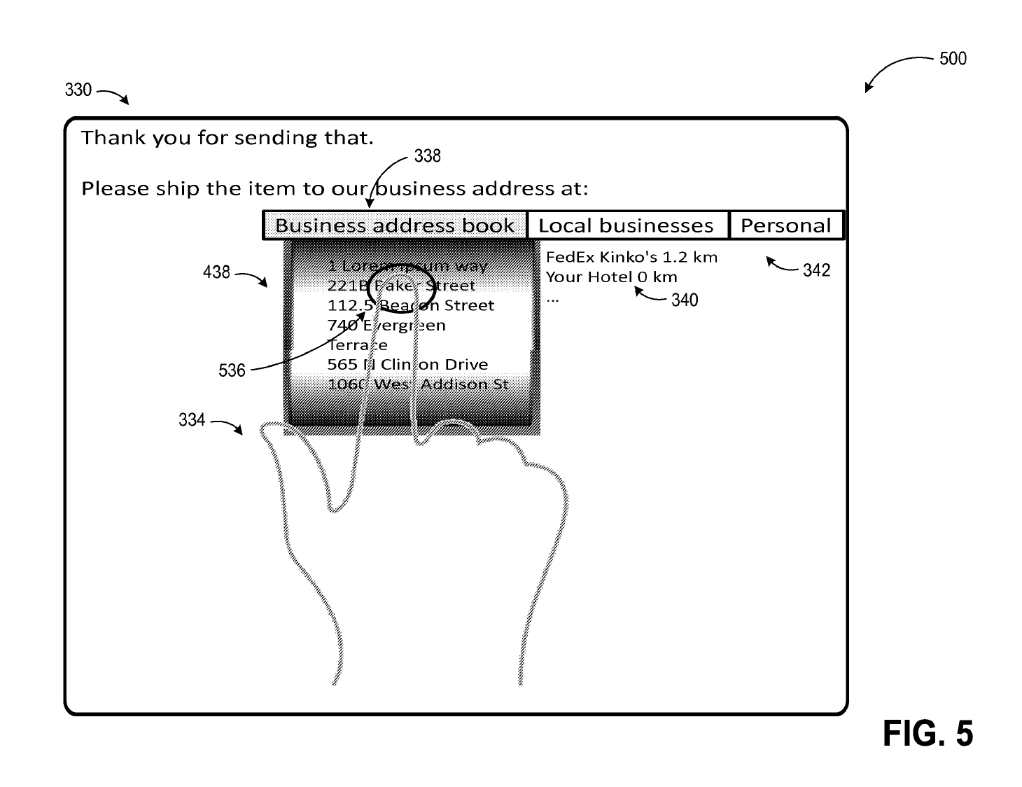

FIG. 5 illustrates selection of auto-fill content in the example user interface of FIG. 4, arranged in accordance with at least some embodiments described herein.

FIG. 5 depicts a diagram 500 similar to the diagram 400 of FIG. 4. In the diagram 500, the user 334 may have selected the contextual domain 338 by making the gesture 436, resulting in the presentation of the selection menu 438. Subsequently, the user may make a gesture 536 to select a specific item (in this case, address) in the presented selection menu 438. In some embodiments, the gesture 536 may differ from the gesture 436. For example, the gestures 536 and 436 may differ in the number of fingers used to touch the display 330 (e.g., one finger versus two fingers), the direction of sliding/movement (horizontal versus vertical), the kind of touch (e.g., a sliding movement, a tap, a pan, a zoom-in/zoom-out motion, etc.) or in any other suitable way. The specific item selected may then be automatically inserted into the targeted input field (e.g., the text entry field 212 in FIG. 2).

In other embodiments, the selection menu 438 may include auto-fill content other than addresses. For example, auto-fill content may include names, contacts, phone numbers, graphics, images, other portions of text, files or links to files, or any other suitable content. Similarly, while FIGS. 3-5 depict an auto-fill process for an input field, in other embodiments an auto-fill process may be used in any application involving content entry, such as a word processor, a spreadsheet, an email or messaging program, or any suitable application. For example, a gesture-based auto-fill process may be used on a file attachment user interface or while drafting an email message to automatically present appropriate attachments based on the textual content of the email. Similarly, a gesture-based auto-fill process may be used to facilitate document creation by providing sentence or paragraph completion as a user is typing, thereby reducing the amount of typing needed. In some embodiments, the sentence/paragraph completion auto-fill process may allow the user to select from a menu of sentences, statements, or paragraphs that have been used in similar contexts.

While the gestures 336, 436, and 536 have been described as touch-based gestures, this need not be the case, and any system capable of gesture recognition may be used. In some embodiments, input from a hardware user interface device such as a mouse, a keyboard, joystick, gamepad, or any other movable input device may be used. In some embodiments, input from visual input devices may be used, such as an eye tracker or a digital camera. As one example, a user device equipped with a camera may be able to recognize a user gesture made within the field of view of the camera. In some embodiments, a user may be able to use the camera to provide context based on an external document or object. A user may hold a document within view of the camera and use a gesture to enable auto-fill functionality based on information (e.g., text, images, etc.) in the document. For example, the user may be able to extract information from the document and “paste” it into a different document, or may be able to perform a search based on the extracted information. In some embodiments, a user may hold a recognizable product or logo within view of the camera and use a gesture to perform a search based on, for example, the product manufacturer or logo owner.

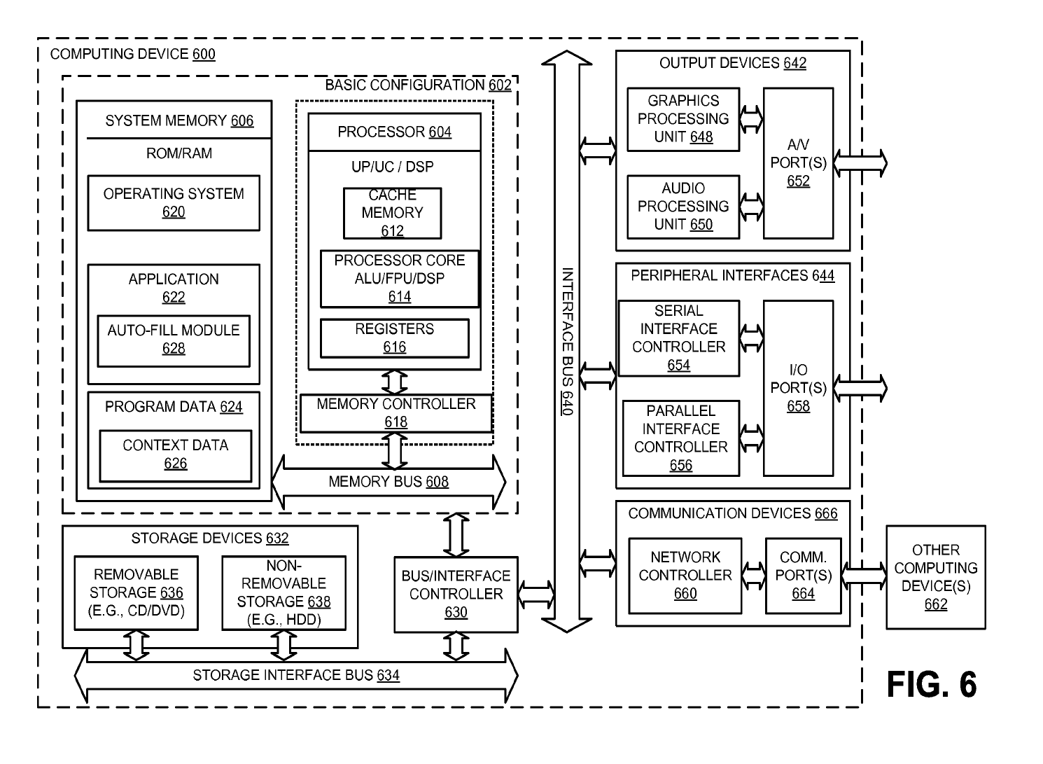

FIG. 6 illustrates a general purpose computing device, which may be used to employ gesture progression to trigger auto-fill, arranged in accordance with at least some embodiments described herein.

For example, the computing device 600 may be used to employ gesture progression to trigger auto-fill as described herein. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof The processor 604 may include one more levels of caching, such as a level cache memory 612, a processor core 614, and registers 616. The example processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, an application 622, and program data 624. The application 622 may include an auto-fill module 628 for employing gesture progression to trigger auto-fill as described herein. The program data 624 may include, among other data, context data 626 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Example embodiments may also include methods for employing gesture progression to trigger auto-fill. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

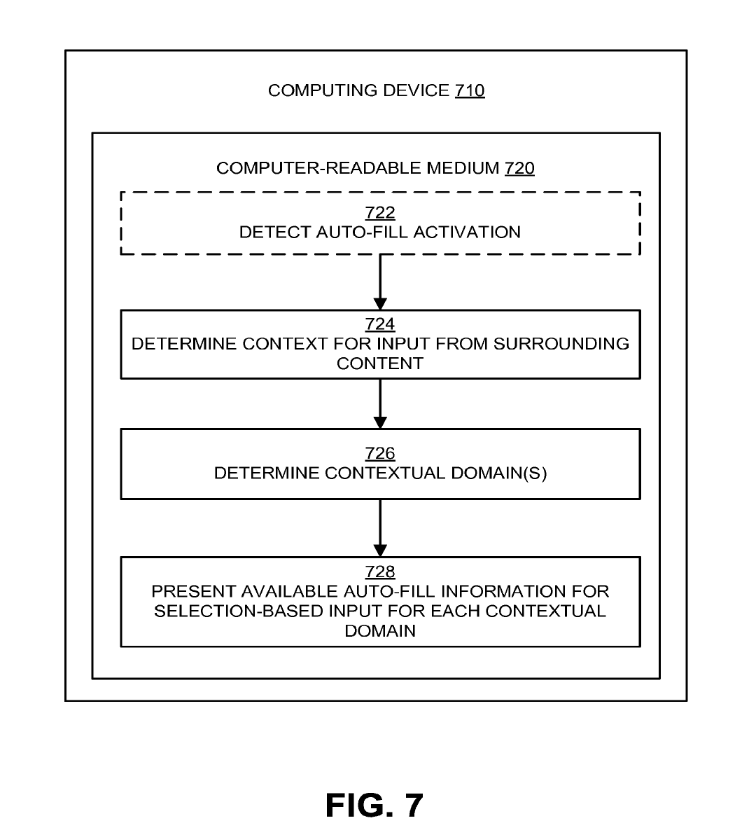

FIG. 7 is a flow diagram illustrating an example method for employing gesture progression to trigger auto-fill that may be performed by a computing device such as the computing device in FIG. 6, arranged in accordance with at least some embodiments described herein.

Example methods may include one or more operations, functions or actions as illustrated by one or more of blocks 722, 724, 726, and/or 728, and may in some embodiments be performed by a computing device such as the computing device 600 in FIG. 6. The operations described in the blocks 722-728 may also be stored as computer-executable instructions in a computer-readable medium such as a computer-readable medium 720 of a computing device 710.

In some embodiments, an example process for employing gesture progression to trigger auto-fill may begin with optional block 722, “DETECT AUTO-FILL ACTIVATION”, where a device (e.g., the first user device 104 or the second user device 106) may detect that a user has activated an auto-fill process. For example, the user may make a gesture (e.g., the gesture 336 in FIG. 3) on a touch-enabled display (e.g., the touch-enabled display 330) or in the view of a camera on the user device as described above.

Block 722 may be followed by block 724, “DETERMINE CONTEXT FOR INPUT FROM SURROUNDING CONTENT”, where context information may be gathered from content associated with a user input by an application executed on the device or by an operating system of the device. For example, if the user input includes touching a display at a specific location (e.g., a text entry field), the associated content may include text or images on the display near the touched location. If the user input includes a gesture made in view of a camera, the associated content may include an object held by the user (e.g., a document or other object) and/or the surroundings of the user (e.g., a street or store sign). In some embodiments, the associated content may include the location of the user, as described above.

Block 724 may be followed by block 726, “DETERMINE CONTEXTUAL DOMAINS”, where the application executed on the device or the operating system of the device may use the contextual information gathered in block 724 to determine one or more contextual domains as described above in relation to FIG. 3.

Finally, block 726 may be followed by block 728, “PRESENT AVAILABLE AUTO-FILL INFORMATION FOR SELECTION-BASED INPUT FOR EACH CONTEXTUAL DOMAIN”, where the contextual domains determined in block 726 may be presented to the user through a display for auto-fill functionality, as described above in relation to FIGS. 3, 4, and 5. For example, the determined contextual domains may be presented to the user in a linear fashion (e.g., as the contextual domains 338, 340, and 342 are presented in FIGS. 3, 4, and 5) or in any other suitable arrangement (e.g., a circle, arc, grid, array, etc.) The user may then be able to select one of the contextual domains (e.g., as in FIG. 4). Subsequently, a selection menu populated with auto-fill information (e.g., the selection menu 438) may be presented to the user, who can then select one or more of the items in the menu for auto-fill.

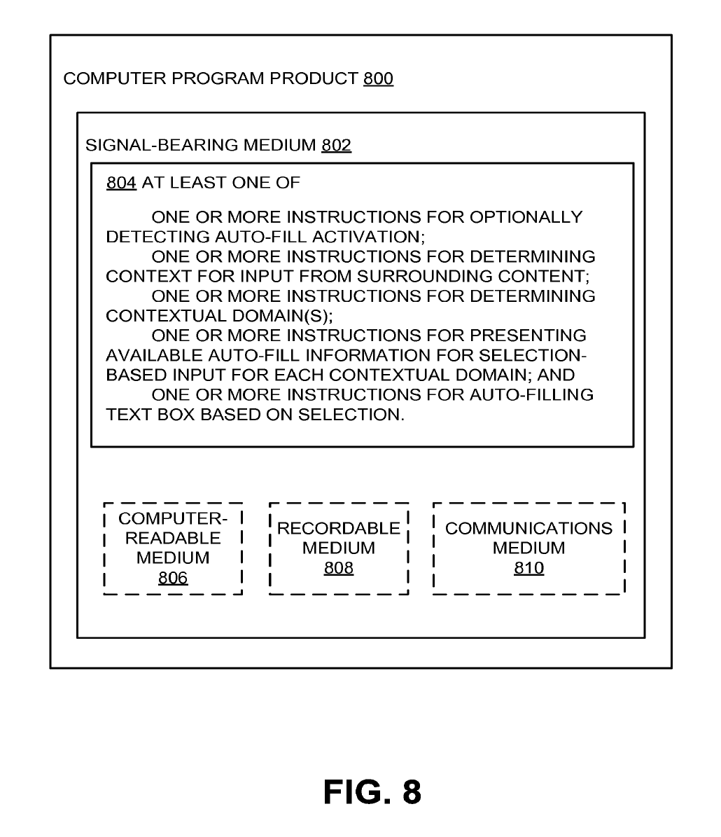

FIG. 8 illustrates a block diagram of an example computer program product, arranged in accordance with at least some embodiments described herein.

In some examples, as shown in FIG. 8, the computer program product 800 may include a signal bearing medium 802 that may also include one or more machine readable instructions 804 that, when executed by, for example, a processor, may provide the functionality described herein. Thus, for example, referring to the processor 604 in FIG. 6, the application 622 may undertake one or more of the tasks shown in FIG. 8 in response to the instructions 804 conveyed to the processor 604 by the medium 802 to perform actions associated with employing gesture progression to trigger auto-fill as described herein. Some of those instructions may include, for example, optionally detecting auto-fill activation, determining context for input from surrounding content, determining contextual domain(s), presenting available auto-fill information for selection-based input for each contextual domain, and auto-filling text box(es) based on the selection, according to some embodiments described herein.

In some implementations, the signal bearing medium 802 depicted in FIG. 8 may encompass a computer-readable medium 806, such as, but not limited to, a hard disk drive, a solid state drive, a Compact Disc (CD), a Digital Versatile Disk (DVD), a digital tape, memory, etc. In some implementations, the signal bearing medium 802 may encompass a recordable medium 808, such as, but not limited to, memory, read/write (R/W) CDs, R/W DVDs, etc. In some implementations, the signal bearing medium 802 may encompass a communications medium 810, such as, but not limited to, a digital and/or an analog communication medium (e.g., a fiber optic cable, a waveguide, a wired communications link, a wireless communication link, etc.). Thus, for example, the program product 800 may be conveyed to one or more modules of the processor 804 by an RF signal bearing medium, where the signal bearing medium 802 is conveyed by the wireless communications medium 810 (e.g., a wireless communications medium conforming with the IEEE 802.11 standard).

According to some examples, a method for employing progressively-triggered auto-fill may include detecting a first action for activating a multi-stage auto-fill, determining a context of a requested input, presenting two or more domains of content based on the context of the requested input, and upon selection of one of the domains through a second action, presenting one or more content options suitable for selection in response to the requested input.

According to some embodiments, the method may further include inserting the selected content option at a location for the requested input upon selection of one of the content options and/or determining the context of the requested input from a contextually-developed list from content through inference, a tag, and/or a field identifier associated with an input field. The method may further include determining the contextually-developed list from one or more words in a vicinity of the requested input and/or employing a natural language processing concordance operation on one or more nearest non-common words. Each domain may include a word and an associated concordance list may be presented upon selection of a domain, and the method may further include employing collaborative filtering in determining the contextually-developed list.

According to other embodiments, the first and second actions may include a touch action, an optically-captured gesture action, a movable input device action, a mouse input, a keyboard input, and/or an eye-tracking action. The first action may be a multi-movement action and the second action may be a single-directional movement action or a tap action. In some embodiments, the first and second actions may include a touch or gesture action, the first action may be a multi-finger motion, and the second action may be a tap, a slide, a pan, a zoom-in, or a zoom-out motion.

According to further embodiments, the method may further include presenting the domains and the content options through a drop-down list, a rolling list, a radial menu, and/or a grid menu. The content options may include text, file attachments, graphics, and/or images. The method may further include separating professional and personal data by a directory structure, keywords, and/or sources in order to prevent cross-usage of confidential material. The requested input may be presented as an input field, a sentence completion on a textual user interface, and/or a file attachment user interface.

According to other examples, a computing device for employing progressively-triggered auto-fill may include a display configured to present a user interface that includes a requested input, an input device configured to detect an action, a memory configured to store instructions, and a processor communicatively coupled to the display, the input device, and the memory. The processor may be configured to detect a first action associated with the input device for activating a multi-stage auto-fill, determine a context of the requested input, present two or more domains of content based on the context of the requested input through the user interface, and upon selection of one of the domains through a second action associated with the input device, present one or more content options suitable for selection in response to the requested input through the user interface.

According to some embodiments, the processor may be further configured to insert the selected content option at a location for the requested input on the user interface upon selection of one of the content options and/or determine the context of the requested input from a contextually-developed list from content through inference, a tag, and/or a field identifier associated with an input field. The processor may be further configured to determine the contextually-developed list from one or more words in a vicinity of the requested input and/or by employing a natural language processing concordance operation on one or more nearest non-common words. Each domain may include a word and an associated concordance list may be presented upon selection of a domain, and the processor may be further configured to employ collaborative filtering in determining the contextually-developed list.

According to other embodiments, the first and second actions may include a touch action, an optically-captured gesture action, a movable input device action, a mouse input, a keyboard input, and/or an eye-tracking action. The first action may be a multi-movement action and the second action may be a single-directional movement action or a tap action. In some embodiments, the first and second actions may include a touch or gesture action, the first action may be a multi-finger motion, and the second action may be a tap, a slide, a pan, a zoom-in, or a zoom-out motion.

According to further embodiments, the processor may be configured to present the domains and the content options through a drop-down list, a rolling list, a radial menu, and/or a grid menu. The content options may include text, file attachments, graphics, and/or images. The processor may be further configured to separate professional and personal data by a directory structure, keywords, and/or sources in order to prevent cross-usage of confidential material. The requested input may be presented as an input field, a sentence completion on a textual user interface, and/or a file attachment user interface.

According to further examples, a system for employing progressively-triggered auto-fill may include at least one server configured to host a service accessible through a client application. The service may be configured to present content through a user interface that includes a requested input, detect a first action for activating a multi-stage auto-fill, determine a context of the requested input, present two or more domains of content based on the context of the requested input through the user interface, and upon selection of one of the domains through a second action associated with the input device, present one or more content options suitable for selection in response to the requested input through the user interface.

According to some embodiments, the service may be further configured to insert the selected content option at a location for the requested input on the user interface upon selection of one of the content options and/or determine the context of the requested input from a contextually-developed list from content through inference, a tag, and/or a field identifier associated with an input field. The service may be further configured to determine the contextually-developed list from one or more words in a vicinity of the requested input.

According to other embodiments, the first and second actions may include a touch action, an optically-captured gesture action, a movable input device action, a mouse input, a keyboard input, and/or an eye-tracking action. The service may be further configured to present the domains and the content options through a drop-down list, a rolling list, a radial menu, and/or a grid menu. The content options may include text, file attachments, graphics, and/or images.

The requested input may be presented as an input field, a sentence completion on a textual user interface, and/or a file attachment user interface.

According to yet further examples, a computer-readable storage medium may store instructions which, when executed on one or more computing devices execute a method for employing progressively-triggered auto-fill. The instructions may include detecting a first action for activating a multi-stage auto-fill, determining a context of a requested input, presenting two or more domains of content based on the context of the requested input, and upon selection of one of the domains through a second action, presenting one or more content options suitable for selection in response to the requested input.

According to some embodiments, the instructions may further include inserting the selected content option at a location for the requested input upon selection of one of the content options and/or determining the context of the requested input from a contextually-developed list from content through inference, a tag, and/or a field identifier associated with an input field. The instructions may further include determining the contextually-developed list from one or more words in a vicinity of the requested input and/or employing a natural language processing concordance operation on one or more nearest non-common words. Each domain may include a word and an associated concordance list may be presented upon selection of a domain, and the method may further include employing collaborative filtering in determining the contextually-developed list.

According to other embodiments, the first and second actions may include a touch action, an optically-captured gesture action, a movable input device action, a mouse input, a keyboard input, and/or an eye-tracking action. The first action may be a multi-movement action and the second action may be a single-directional movement action or a tap action. In some embodiments, the first and second actions may include a touch or gesture action, the first action may be a multi-finger motion, and the second action may be a tap, a slide, a pan, a zoom-in, or a zoom-out motion.

According to further embodiments, the instructions may further include presenting the domains and the content options through a drop-down list, a rolling list, a radial menu, and/or a grid menu. The content options may include text, file attachments, graphics, and/or images. The instructions may further include separating professional and personal data by a directory structure, keywords, and/or sources in order to prevent cross-usage of confidential material. The requested input may be presented as an input field, a sentence completion on a textual user interface, and/or a file attachment user interface.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or^{,} “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for employing progressively-triggered auto-fill, the method comprising:
detecting a first action for activating a multi-stage auto-fill;
determining a context of a requested input from one or more words in a vicinity of the requested input;
presenting two or more domains of content based on the context of the requested input; and
upon selection of one of the domains through a second action, presenting one or more content options suitable for selection in response to the requested input.

2. The method of claim 1, further comprising:
upon selection of one of the content options, inserting the selected content option at a location for the requested input.

3. The method of claim 1, further comprising:
determining the context of the requested input from one or more of a contextually developed list from content through inference, a tag, and a field identifier associated with an input field.

4. (canceled)

5. The method of claim 3, further comprising:
determining the contextually-developed list by employing a natural language processing concordance operation on one or more nearest non-common words.

6. (canceled)

7. The method of claim 5, further comprising:
employing collaborative filtering in determining the contextually-developed list.

8-10. (canceled)

11. The method of claim 1, further comprising:
presenting the domains and the content options through one or more of a drop-down list, a rolling list, a radial menu, and a grid menu.

12. (canceled)

13. The method of claim 1, further comprising:
separating professional and personal data by one or more of a directory structure, keywords, and sources in order to prevent cross-usage of confidential material.

14. (canceled)

15. A computing device for employing progressively-triggered auto fill, the computing device comprising:
a display configured to present a user interface that includes a requested input;
an input device configured to detect an action;
a memory configured to store instructions; and
a processor communicatively coupled to the display, the input device, and the memory, the processor configured to:
detect a first action associated with the input device for activating a multi-stage auto-fill;
determine a context of the requested input from one or more words in a vicinity of the requested input;
present two or more domains of content based on the context of the requested input through the user interface; and
upon selection of one of the domains through a second action associated with the input device, present one or more content options suitable for selection in response to the requested input through the user interface.

16-18. (canceled)

19. The computing device of claim 17, wherein the processor is further configured to:
determine the contextually developed list by employing a natural language processing concordance operation on one or more nearest non-common words.

20. The computing device of claim 19, wherein each domain comprises a word and an associated concordance list is presented upon selection of a domain.

21. The computing device of claim 19, wherein the processor is further configured to:
employ collaborative filtering in determining the contextually developed list.

22. The computing device of claim 15, wherein the first and second actions comprise one or more of: a touch action, an optically-captured gesture action, a movable input device action, a mouse input, a keyboard input, and an eye-tracking action.

23. The computing device of claim 22, wherein the first action is a multi-movement action and the second action is one of a single-directional movement action or a tap action.

24. The computing device of claim 22, wherein
the first and second actions comprise a touch or gesture action,
the first action is a multi-finger motion, and
the second action is one of a tap, a slide, a pan, a zoom-in, or a zoom-out motion.

25. (canceled)

26. The computing device of claim 15, wherein the content options include one of text, file attachments, graphics, or images.

27. (canceled)

28. The computing device of claim 15, wherein the requested input is presented as one of an input field, a sentence completion on a textual user interface, or a file attachment user interface.

29. A system for employing progressively-triggered search based auto fill, the system comprising:
at least one server configured to host a service accessible through a client application, the service configured to:
present content through a user interface that includes a requested input;
detect a first action for activating a multi-stage auto-fill;
determine a context of the requested input from one or more words in a vicinity of the requested input;
present two or more domains of content based on the context of the requested input through the user interface; and
upon selection of one of the domains through a second action associated with the input device, present one or more content options suitable for selection in response to the requested input through the user interface.

30. The system of claim 29, wherein the service is further configured to:
upon selection of one of the content options, insert the selected content option at a location for the requested input on the user interface.

31. The system of claim 29, wherein the service is further configured to:
determine the context of the requested input from one or more of a contextually-developed list from content through inference, a tag, and a field identifier associated with an input field.

32. (canceled)

33. The system of claim 29, wherein the first and second actions comprise one or more of: a touch action, an optically captured gesture action, a movable input device action, a mouse input, a keyboard input, and an eye-tracking action.

34. The system of claim 29, wherein the service is further configured to:
present the domains and the content options through one or more of a drop-down list, a rolling list, a radial menu, and a grid menu.

35. The system of claim 29, wherein the content options include one of text, file attachments, graphics, or images.

36. The system of claim 29, wherein the requested input is presented as one of an input field, a sentence completion on a textual user interface, or a file attachment user interface.

37. (canceled)
